(19) United States
(12) Patent Application Publication
(10) Pub. No.: US 2008/0019242 A1
(43) Pub. Date: Jan. 24, 2008

(54) OPTICAL DISC AND OPTICAL DISC APPARATUS

(75) Inventors: Kenji Nakao, Gifu-city (JP); Morio Nakatani, Ichinomiya-City (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 11/780,914

(22) Filed: Jul. 20, 2007

(30) Foreign Application Priority Data
Jul. 20, 2006 (JP) 2006-197675

(51) Int. Cl. G11B 20/10

(52) U.S. Cl. 369/47.5

(57) ABSTRACT

A control data area of an optical disc holds correction information for correcting a recording laser power Pmax determined by performing trial writing. The recording laser power Pmax determined by trial writing is corrected on the basis of the correction information stored in the control data area, thereby setting a recording laser power Popt used for making a recording.

This application claims priority under 35 U.S.C. Section 119 of Japanese Patent Application No. 2006-197675 filed Jul. 20, 2006, entitled “OPTICAL DISC AND OPTICAL DISC APPARATUS”.

### BACKGROUND OF THE INVENTION

1. Field of the Invention

The present invention relates to an optical disc and an optical disc apparatus, and more specifically, is suitable for use as a technique to set a recording laser power.

2. Description of the Related Art

In an HD DVD-R (High Definition Digital Versatile Disc-Recordable) of which commercialization is currently under way, trial writing is performed in a predetermined trial writing area to make initial setting of a recording laser power, as in the existing CD-R (Compact Disc-Recordable) and DVD-R (Digital Versatile Disc-Recordable).

In general, the recording laser power is initially set to a value associated with the best recording characteristics. For an HD DVD-R, for example, a recording laser power associated with the maximum PRSNR (Partial Response Signal to Noise Ratio) or the lowest reproduction error rate is set as the recording laser power suitable for the disc.

The inventors have verified, however, that in the case of making a recording with the power associated with the best recording characteristics as described above, reproducing characteristics suffered gradual degradation as reproduction (tracing) was performed an increasing number of times with respect to the recording area, and that these characteristics could not be maintained at the desired levels until the number of times of reproduction reached the value defined in the HD DVD standard.

For instance, the HD DVD standard requires that the PRSNR of reproduction data be 15 or more even after reproduction is repeated one million times. Nevertheless, the inventors have made a recording on an HD DVD-R with the recording laser power associated with the highest PRSNR that was determined by means of trial writing, and have revealed that the PRSNR did not meet the condition, PRSNR≧15, when the number of reproductions reached only about 500 thousands.

This seems to be caused by the action of dye materials contained in a recording layer and characteristics of a recording layer. It is thus considered that the power associated with the best recording characteristics can cause the recording layer to be deteriorated or suffer adverse effects in some ways during reproduction (tracing) due to an increasing number of times of reproduction.

### SUMMARY OF THE INVENTION

A first aspect of the present invention relates to an optical disc. The optical disc according to this aspect comprises a control data area for prepared control data, a main data area capable of recording main data, and a trial writing area in which trial writing is performed for setting of a recording laser power. The control data area holds correction information for correcting a recording laser power Pmax associated with the best recording characteristics that is determined via trial writing in the trial writing area, thereby setting a recording laser power Popt used for making a recording on the disc.

A second aspect of the present invention relates to an optical disc apparatus. The optical disc apparatus according to this aspect records the main data on the optical disc according to the first aspect. Further, the optical disc apparatus has a correction information acquisition part for acquiring the correction information; a power determination part for determining the recording laser power Pmax associated with the best recording characteristics via trial writing in the trial writing area; and a power setting part for setting the recording laser power Popt used for making a recording on the optical disc, by correcting the recording laser power Pmax determined by the power determination part, based on the correction information acquired by the correction information acquisition part.

### BRIEF DESCRIPTION OF THE DRAWINGS

The above-described and other objects and novel features will become more fully appreciated when reading the following description of the embodiments with reference to the appended drawings.

FIG. 1 shows a configuration of an optical disc according to an embodiment of the present invention.

FIG. 2 shows an area format of the optical disc according to the embodiment of the present invention.

FIG. 3 shows a configuration of an optical disc apparatus according to an embodiment of the present invention.

FIG. 4 is a flow chart of an OPC process according to the embodiment of the invention.

FIGS. 5A and 5B show a method of setting a recording laser power according to the embodiment of the present invention.

FIG. 6 shows an example of verification according to the embodiment of the present invention.

FIG. 7 is a flow chart of an OPC process according to a modified embodiment of the present invention.

These drawings are only for the purpose of description and are not intended to limit the scope of the present invention.

### DESCRIPTION OF PREFERRED EMBODIMENTS

Embodiments of the present invention will be described below with reference to the drawings. In these embodiments, the present invention is applied to an HD DVD-R using a blue-violet laser beam and a drive apparatus thereof.

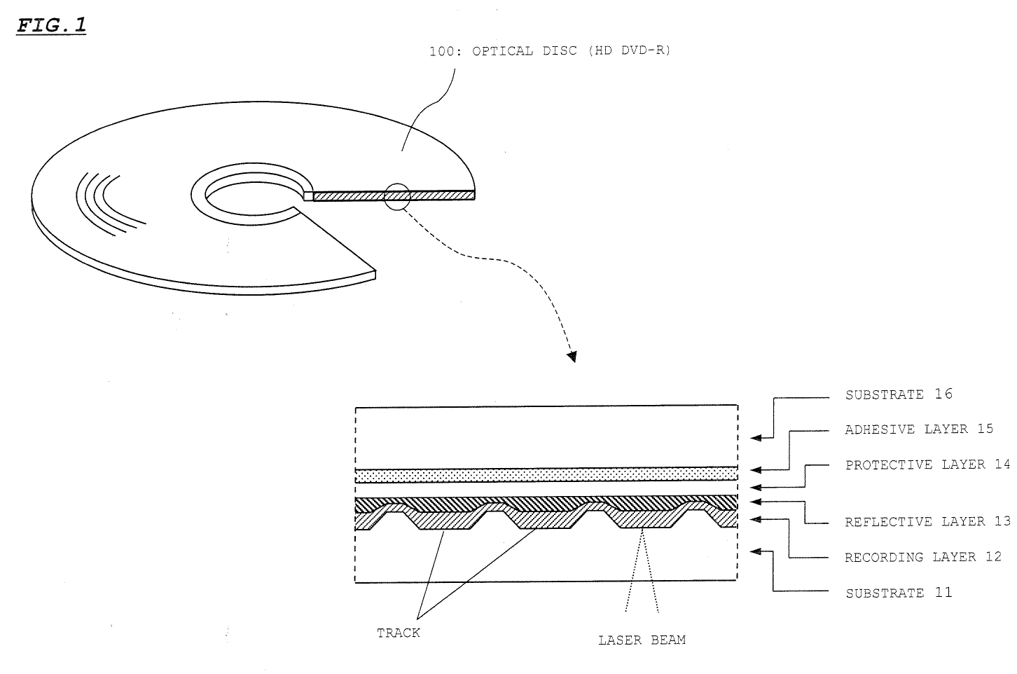

FIG. 1 illustrates a configuration of an optical disc (HD DVD-R) 100.

As shown in the drawing, the optical disc 100 is formed by providing a recording layer 12, a reflective layer 13 and a protective layer 14 on a substrate 11 and attaching a substrate 16 to the protective layer 14 with an adhesive layer 15 interposed therebetween. The recording layer 12 is composed of predetermined dye materials.

The recording layer 12 is provided with a spiral track (groove) extending from the inner circumference to the outer circumference. Data is recorded and reproduced with respect to this track. The track snakes (wobbles) along the disc diameter. Its wobble allows address information to be held. More specifically, phase-modulated sections called ADIP (Address in pre-groove) are inserted into a monotonous snaking area at a certain frequency. When a beam scans these phase-modulated sections, address information on the track is read and reproduced on the basis of changes in the intensity of reflected light.

Further, PFI (Physical Format Information) of a system lead-in (SLI) contains various types of control data (lead-in information) for the disc in pits. The lead-in information includes a correction factor ν for adjustment of the recording laser power.

The correction factor ν is used to make a correction to the recording laser power Pmax that provides the disc with the best recording characteristics, thereby setting a recording laser power suitable for the disc. In this embodiment, for setting of the recording laser power, firstly trial writing is performed in a trial writing area of the disc. By the trial writing, the recording laser power Pmax associated with the highest PRSNR (Partial Response Signal to Noise Ratio) is determined. Then, the Pmax is multiplied by the correction factor ν to acquire a recording laser power Popt suitable for the disc.

The correction factor ν is here set to such a value that the recording laser power Popt becomes smaller in a given proportion than the recording laser power Pmax (e.g. about 0.9). For example, the correction factor ν is set to such a value that the PRSNR of a recording signal does not fall below the standard limit value (PRSNR-15) even if reproduction (tracing) is repeated a number of times in accordance with the standard (one million times for HD DVD-R). The correction factor ν is set by a manufacturer considering the dye materials contained in the recording layer 12 and the film thickness of the recording layer 12. More specifically, recording is made on a target disc with variations in the correction factor ν.

Then, verification is carried out as to a relationship between the number of times the recorded portion has been reproduced (traced) and the PRSNR, thereby setting the correction factor ν that is considered to be best suited for the disc.

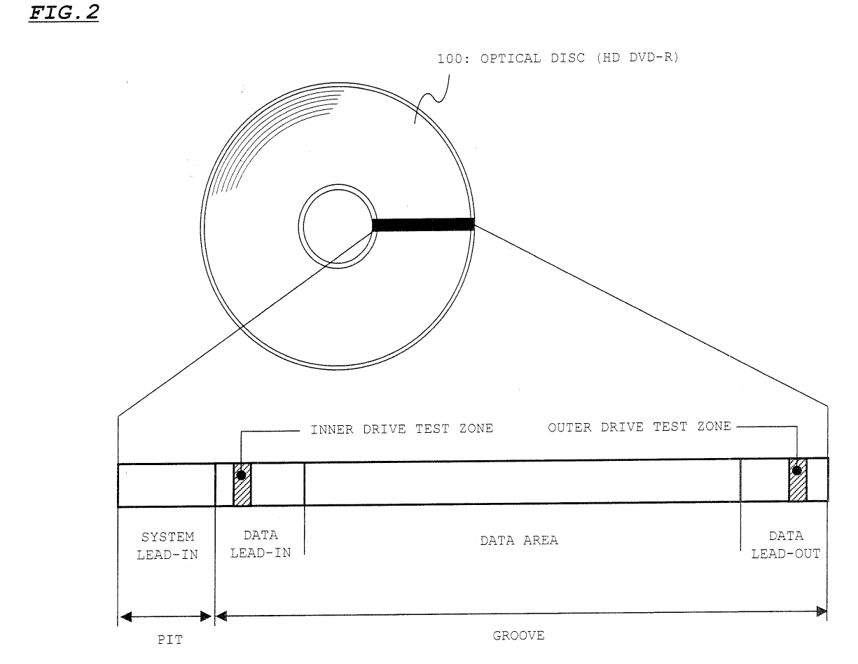

FIG. 2 illustrates an area format of the optical disc 100.

As shown in the drawing, the disc 100 is divided along the diameter into a system lead-in area, a data lead-in area, a data area, and a data lead-out area. The data lead-in area and the data lead-out area are subdivided into various zones. Among these zones, an inner drive test zone and an outer drive test zone are used for initial setting of the recording laser power (OPC: Optimum Write Power Control).

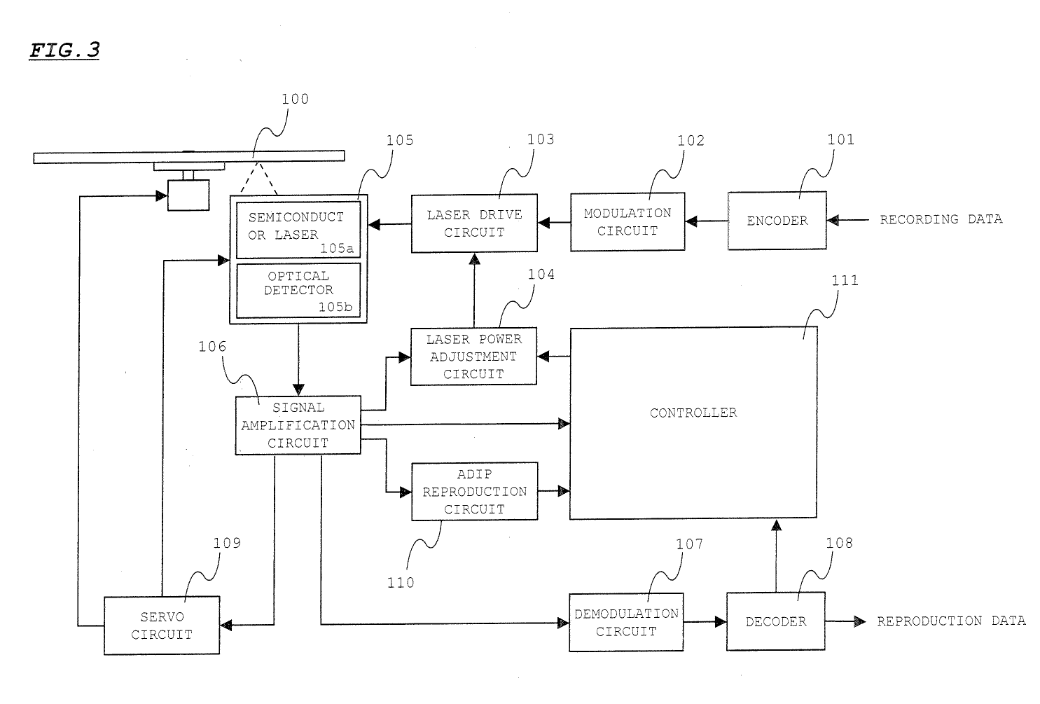

FIG. 3 illustrates a configuration of an optical disc apparatus according to an embodiment of the present invention.

As shown in the drawing, the optical disc apparatus comprises an encoder 101, a modulation circuit 102, a laser drive circuit 103, a laser power adjustment circuit 104, an optical pickup 105, a signal amplification circuit 106, a demodulation circuit 107, a decoder 108, a servo circuit 109, an ADIP reproduction circuit 110, and a controller 111.

The encoder 101 subjects the input recording data to an encode process including the addition of an error correction code, and outputs the data to the modulation circuit 102. The modulation circuit 102 performs a predetermined modulation on the input recording data, generates a recording signal and then outputs it to the laser drive circuit 103. The laser drive circuit 103 outputs to a semiconductor laser 105a a drive signal corresponding to the recording signal from the modulation circuit 102 at the time of recording, and outputs to the semiconductor laser 105a a drive signal for emitting a laser beam of certain intensity at the times of reproduction. The laser power here is set as the laser power adjusted by the laser power adjustment circuit 104.

The laser power adjustment circuit 104 sets the laser power for recording and reproducing in accordance with the setting value input from the controller 111. Further, the laser power adjustment circuit 104 adjusts the setting of the recording laser power input from the controller 111, depending on a reproduction signal input from the signal amplifier circuit 106 (R-OPC: Running-OPC).

The optical pickup 105 comprises the semiconductor laser 105a and an optical detector 105b, and writes and reads data onto and from the disc by focusing a laser beam to the groove. The optical pickup 105 further comprises an object lens actuator for adjusting the laser-beam irradiation state of the groove; and an optical system for guiding a laser beam emitted from the semiconductor laser 105a to the object lens and guiding the beam reflected from the disc 100 to the optical detector 105b.

The signal amplification circuit 106 amplifies the signal received from the optical detector 105b and performs arithmetic operations on the signal to generate various signals, and then outputs them to the corresponding circuits. The demodulation circuit 107 demodulates the reproduction RF signal input from the signal amplification circuit 106 to generate the reproduction data, and then outputs the data to the decoder 108. The decoder 108 subjects the data input from the demodulation circuit 107 to a decode process including error correction, and then outputs the data to the subsequent-stage circuit.

The servo circuit 109 generates a focus servo signal and a tracking servo signal from the focus error signal and the tracking error signal input from the signal amplification circuit 106, and outputs these signals to the object lens actuator of the optical pickup 105. Further, the servo circuit 109 generates a motor servo signal from the wobble signal input from the signal amplification circuit 106, and outputs the signal to the disc drive motor.

The ADIP reproduction circuit 110 reproduces the address information and the like from the wobble signal input from the signal amplification circuit 106, and outputs them to the controller 111.

The controller 111 stores these various types of data in a built-in memory and controls each of the parts according to the pre-set programs. The controller 111 holds a laser power used for the initial trial writing (OPC).

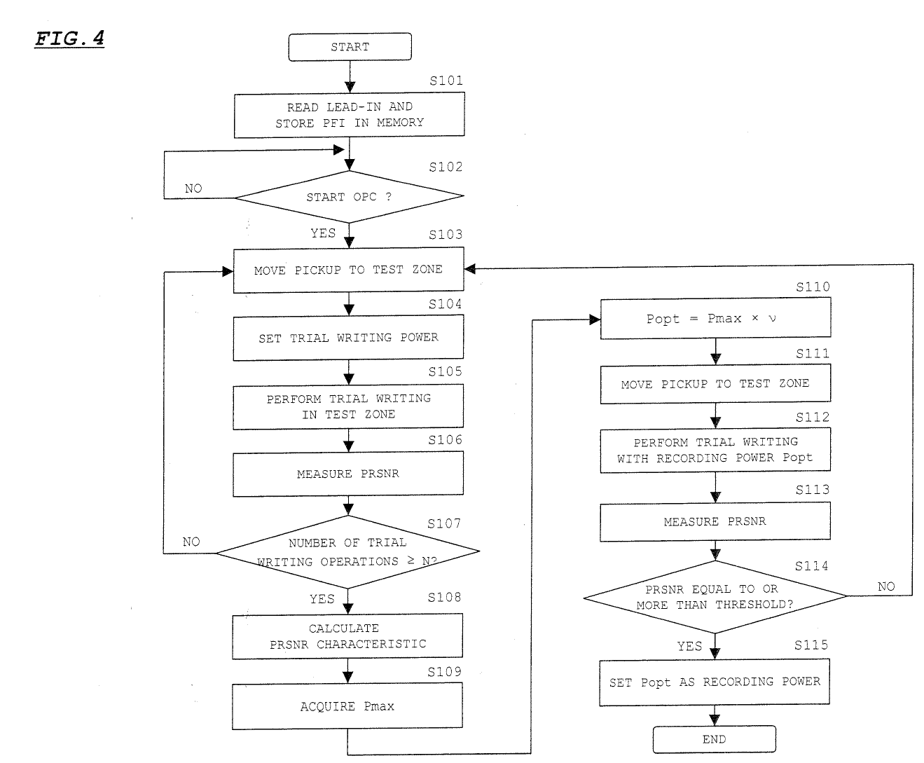

FIG. 4 represents an OPC process flow.

Upon loading of a disc, the PFI of the system lead-in area is read and stored in the built-in memory of the controller 111 (S101). Subsequently, when OPC is started (S102:Y), the controller 111 moves the optical pickup 105 to a trial writing area (inner drive test zone/outer drive test zone) (S103) and performs a first trial writing in the trial writing area with the power held in the built-in memory (S104, S105). At completion of the first trial writing, the controller 111 reads a signal recorded in the trial writing area and measures the PRSNR from the demodulated data at the time (S106).

Then, the controller 111 moves the optical pickup 105 to a next trial writing area (S103) and performs a second trial writing in the trial writing area with a power different from that for the first trial writing (S104, S105). The power for the second trial writing is set on the basis of the power for the first trial writing and the magnitude of the PRSNR at the time. Upon completion of the second trial writing, the controller 111 reads a signal recorded in the trial writing area and measures the PRSNR from the demodulated data at the time (S106).

After that, the controller 111 moves the optical pickup 105 to a further next trial writing (S103) and performs a third trial writing in the trial writing area with a power different from those for the first and second trial writings (S104, S105). The power for the third trial writing is set on the basis of the powers for the first and second trial writings and the magnitudes of the PRSNRs at those times. Upon completion of the third trial writing, the controller 111 reads a signal recorded in the trial writing area and measures the PRSNR from the demodulated data at the time (S106).

If the number of trial writings to be performed N is set to 3, after the completion of the third trial writing and PRSNR measurement based on the trial writing (S107: Y), the controller 111 acquires PRSNR characteristics that define a relationship between the recording laser power and the PRSNR (S108), and determines the recording laser power Pmax associated with the highest PRSNR from the acquired PRSNR characteristics (S109). Further, the controller 111 multiplies the Pmax determined at S109 by the correction factor ν acquired from the disc at S101, thereby determining the recording laser power Popt suitable for the disc (s110).

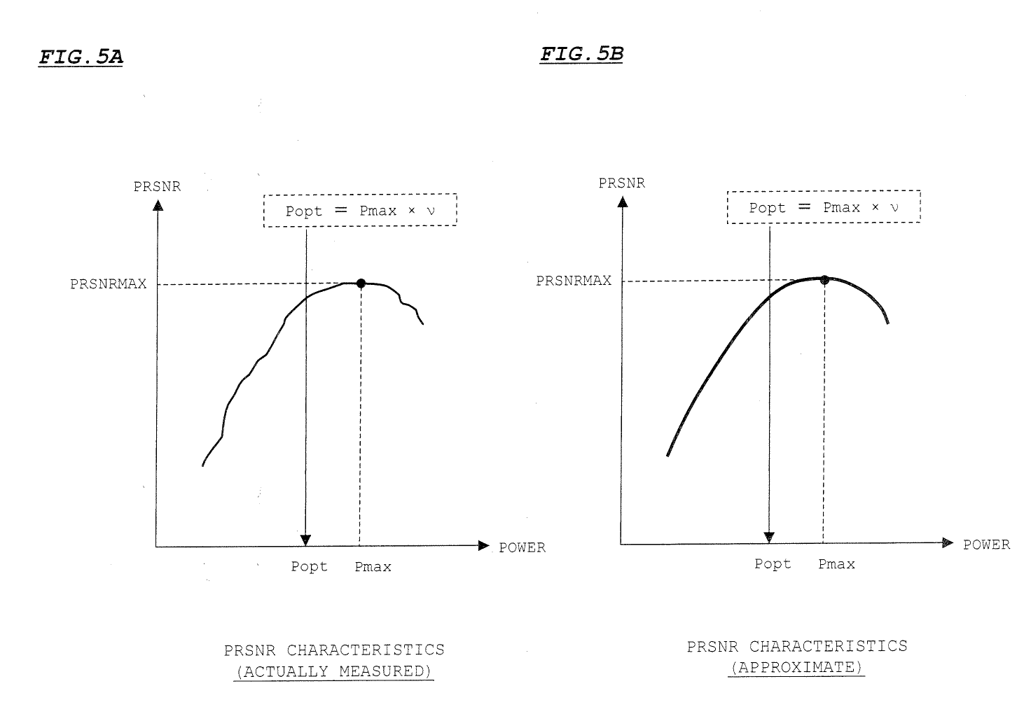

FIGS. 5A and 5B represent the flows of the above described steps S108 to S110.

The PRSNR characteristics for the disc exhibit generally a waveform as shown in FIG. 5A. At S108, an approximate curve as shown in FIG. 5B is derived from three points on the waveform. Next, at S109, the recording laser power Pmax associated with the highest PRSNR is determined from the approximate curve. Then, at S110, the recording laser power Pmax is multiplied by the correction factor ν to determine the recording laser power Popt suitable for the disc.

Returning to FIG. 4, when the recording laser power Popt is determined as described above, the controller 111 moves the optical pickup 105 to a trial writing area (S111), and performs a trial writing in the trial writing area with the recording laser power Popt determined at S110 (S112). The controller 111 further reads a signal recorded in the trial writing area and measures the PRSNR from the demodulated data at the time (S113).

If the measured PRSNR is equal to a predetermined threshold value or more (e.g. PRSNR≧20) (S114: Y), the controller 111 sets the recording laser power Popt acquired at S110 as initial value of the recording laser power suitable for the disc. On the contrary, if the measured PRSNR is less than the predetermined threshold value (e.g. PRSNR<20) (S114: N), the controller 111 discards the recording laser power Popt acquired at S110, and then executes the process from S103 onward again to acquire a new recording laser power Popt.

If YES is not given at S114 even after the process of acquiring the recording laser power Popt is repeated a given number of times, the controller 111 assumes the disc as defective and discontinues the OPC process. At that time, the controller 111 notifies the user of the defective disc via a notification means such as a speaker (not shown).

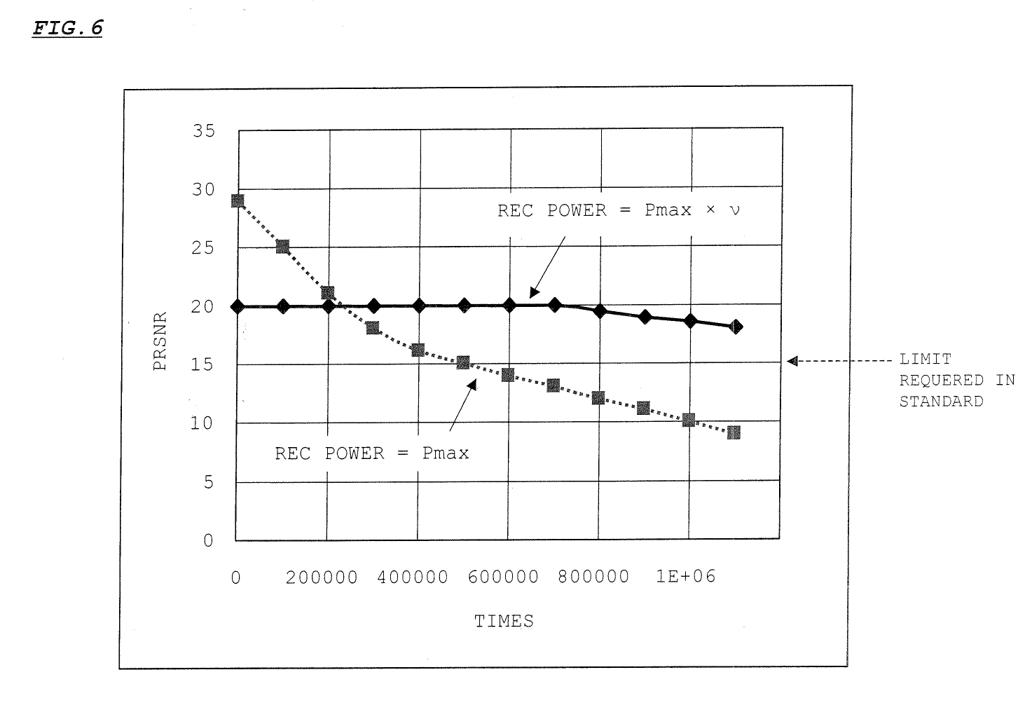

FIG. 6 represents the verification results of actual measurement of changes in the PRSNR with respect to the number of times of reproduction (tracing) when actual recording was made on an HD DVD-R from a disc manufacturer A, with the recording laser powers Pmax and Popt. The verification test was carried out on the so-called low-to-high-type HD DVD-R in which the formation of a recording mark allows a higher reflectivity. The correction factor ν was set to 0.9. The lateral axis in the drawing represents the number of times of reproduction (tracing), and the vertical axis represents the PRSNR.

As shown in the drawing, it can be understood that, while the number of times of reproduction is yet smaller, recording with the recording laser power Pmax (associated with the highest PRSNR) would achieve a higher PRSNR than recording with a power determined by multiplying the Pmax by the correction factor ν (ν=0.9). However, the PRSNRs of the two powers are gradually closer to each other as reproduction is repeated an increased number of times, and thus when the number of times of reproduction eventually exceeds 200 thousands, a higher PRSNR can be acquired by the recording with a power determined by multiplying the Pmax by the correction factor ν (ν=0.9). Further, when the number of times of reproduction exceeds 500 thousands, recording with the recording laser power Pmax does not satisfy the standard limit PRSNR≧15.

In contrast, if recording is performed with the power determined by multiplying the Pmax by the correction factor ν, the PRSNR is hardly changed even after the number of times of reproduction reaches 700 thousands, from the early stage of the reproduction, and it also satisfies the standard limit PRSNR≧15 even after the number of times of reproduction exceeds one million. Further, this recording approach satisfies, while the number of times of reproduction is smaller, the standard PRSNR≧20 with which it is expected to achieve generally good reproduction, and thus provides favorable reproducing characteristics.

As apparent from this verification, it is possible, according to this embodiment, to maintain high reliability of the recording data with respect to the number of times of reproduction, as compared to the recording with the recording laser power Pmax (associated with the highest PRSNR). According to this embodiment, the PRSNR does not fall below the standard limit even if reproduction is repeated a standard number of times (one million). Further, even if reproduction is repeatedly performed a considerably large number of times, the PRSNR suffers very little degradation and maintains good reproducing characteristics. According to this embodiment, it is thus possible to achieve good and stable recording and reproducing characteristics.

As above, specific embodiments of the present invention have been described, but the present invention is not limited to these embodiments.

Additionally, although the recording laser power Pmax is determined on the basis of the PRSNR in the above described embodiments, it may be determined in other ways.

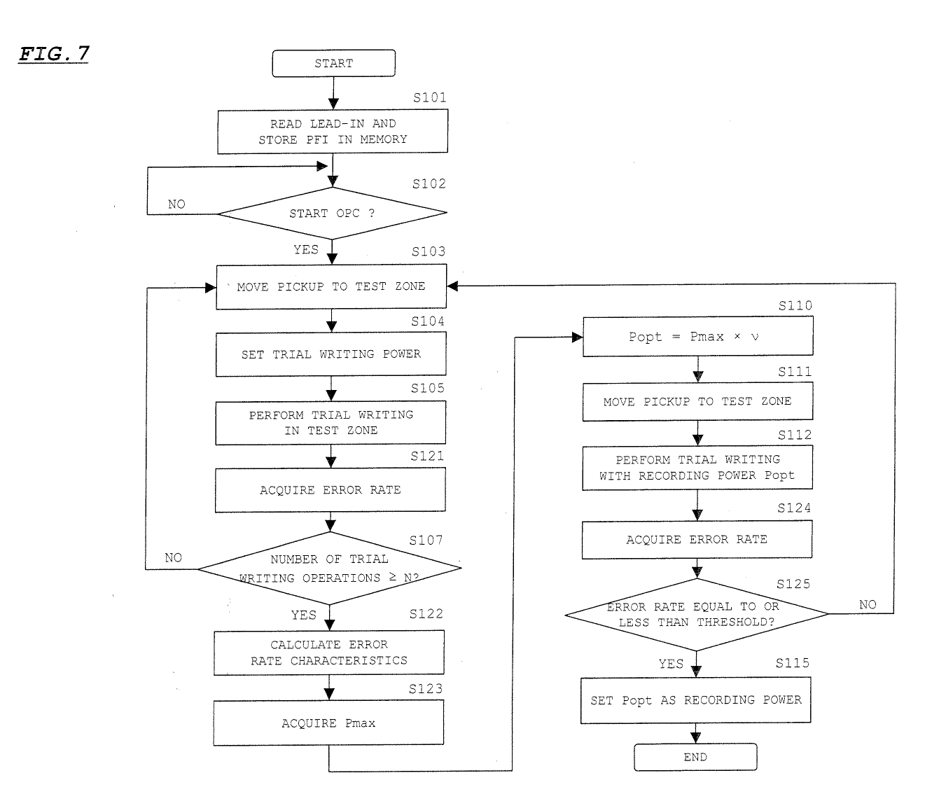

FIG. 7 represents a flow chart of a process of determining the recording laser power Pmax based on the error rate of reproduction data. In this flow chart, S106, S108, S109, S113 and S114 in FIG. 4 are substituted by S121, S122, S123, S124 and S125, respectively.

At S121, the decoder 108 supplies the controller 111 with an error rate in the reproduction of a trial writing area. At S122, based on N error rates acquired from N trial writings, the controller 111 determines an approximate curve that defines a relationship between the recording laser power and the error rate(s). At S123, from the approximate curve determined at S122, the controller 111 determines the recording laser power Pmax associated with the minimum error rate.

Subsequently, the controller 111 multiplies the Pmax determined at S123 by the correction factor ν acquired from the disc at S101, as in the process shown in FIG. 4, thereby acquiring the recording laser power Popt that is suitable for the disc. The controller 111 then moves the optical pickup 105 to a trial writing area (S111), performs trial writing in the trial writing area with the recording laser power Popt determined at S110 (S112), reads out a signal recorded in the trial writing and acquires the error rate at the time from the decoder 108 (S124).

If the obtained error rate is equal to or less than the predetermined threshold value (S125: Y), the controller 111 sets the recording laser power Popt acquired at S110 as initial value of the recording laser power suitable for the disc (S115). On the other hand, if the acquired error rate is more than the predetermined threshold value (S125: N), the controller 111 discards the recording laser power Popt acquired at S110 and then executes the process from S103 onward again to determine a new recording laser power Popt.

In the process flow shown in FIG. 7, the same advantages can be achieved as in that shown in FIG. 4. Although no verification test has been carried out in setting the recording laser powers Pmax and Popt based on the error rate, it is expected that the same advantages will be achieved as shown in FIG. 6 by setting the appropriate correction factor ν.

Although the above embodiments have been described using an HD DVD-R as an example, the present invention is also applicable to other recordable discs such as rewritable HD DVD-RW (HD DVD-Rerecordable) and Blu-ray discs, rewritable discs and drive apparatuses thereof. Further, although the verification process shown in FIG. 6 was carried out with the use of a low-to-high-type HD DVR-R, the present invention is not limited to this type of optical discs and can also be applied to the so-called high-to-low-type optical discs in which reflectivity is lowered by formation of a recording mark. Moreover, the examples described with regard to the above embodiments use the PRSNR or error rate as an evaluation criterion in determining the recording laser power Pmax. Alternatively, the recording laser power Pmax may be determined from any other evaluation criterion such as a jitter or CN.

The embodiments of the present invention can be modified as appropriate within the scope of technical idea of the claims.

What is claimed is:

1. An optical disc, comprising:
a control data area for prepared control data;
a main data area capable of recording main data; and
a trial writing area in which trial writing is performed at setting of a recording laser power, wherein
the control data area holds correction information to correct a recording laser power Pmax associated with the best recording characteristics, which is determined by performing trial writing in the trial writing area, thereby setting a recording laser power Popt used for making a recording onto the disc.

2. The optical disc according to claim 1, wherein
the correction information is information for correcting the recording laser power Pmax so as to raise resistance with respect to the number of times of tracing a recording mark.

3. The optical disc according to claim 1, wherein
the correction information is a correction factor ν for calculating the recording laser power Popt by multiplying the recording laser power Pmax thereby.

4. The optical disc according to claim 3, wherein
the correction factor ν is set to a value of less than 1.

5. An optical disc apparatus for recording main data in an optical disc, wherein
the optical disc comprises a control data area for prepared control data, a main data area capable of recording the main data, and a trial writing area in which trial writing is performed at setting of a recording laser power, the control data area holding correction information so as to correct a recording laser power Pmax associated with best recording characteristics, which is determined by performing trial writing in the trial writing area, thereby setting a recording laser power Popt used for making a recording onto the disc, the optical disc apparatus comprising:
a correction information acquisition part for acquiring the correction information;
a power determination part for determining the recording laser power Pmax associated with best recording characteristics by performing trial writing in the trial writing area; and
a power setting part for setting the recording laser power Popt used for making a recording onto the optical disc, by correcting the recording laser power Pmax determined by the power determination part, based on the correction information acquired by the correction information acquisition part.

6. The optical disc apparatus according to claim 5, wherein
the correction information is a correction factor ν for calculating the recording laser power Popt by multiplying the recording laser power Pmax thereby, and
the power setting part sets the recording laser power Popt by performing a calculation Popt=Pmax×ν.

7. The optical disc apparatus according to claim 5, wherein
based on a result of trial writing in the trial writing area, the power determination part determines a recording laser power associated with a best PRSNR of reproduction data with respect to the disc, as the recording laser power Pmax.

8. The optical disc apparatus according to claim 5, wherein
based on a result of trial writing in the trial writing area, the power determination part determines a recording laser power associated with an optimum reproduction error rate with respect to the disc, as the recording laser power Pmax.

9. An optical disc apparatus for recording main data in an optical disc, wherein
the optical disc comprises a control data area for prepared control data, a main data area capable of recording the main data, and a trial writing area in which trial writing is performed at setting of a recording laser power, the control data area holding correction information to correct a recording laser power Pmax associated with best recording characteristics, which is determined by performing trial writing in the trial writing area, thereby setting a recording laser power Popt used for making a recording onto the disc, the optical disc apparatus comprising:
an optical pickup;
a recording circuit for making a recording onto the optical disc;
a reproduction circuit for reproducing data from the optical disc; and
a controller for controlling the optical pickup, the recording circuit and the reproducing circuit, wherein the controller performs:
a correction information acquisition process of acquiring the correction information;
a power determination process of determining the recording laser power Pmax associated with best recording characteristics by performing trial writing in the trial writing area; and
a power setting process of setting the recording laser power Popt used for making a recording onto the optical disc, by correcting the recording laser power Pmax determined in the power determination process, based on the correction information acquired in the correction information acquisition process.

10. The optical disc apparatus according to claim 9, wherein
the correction information is a correction factor ν for calculating the recording laser power Popt by multiplying the recording laser power Pmax thereby, and
the power setting process sets the recording laser power Popt by performing a calculation Popt=Pmax×ν.

11. The optical disc apparatus according to claim 9, wherein
the power determination process includes a process of determining a recording laser power associated with a best PRSNR of reproduction data with respect to the disc based on a result of the trial writing in the trial writing, as the recording laser power Pmax.

12. The optical disc apparatus according to claim 9, wherein
the power determination process includes a process of determining a recording laser power associated with an optimum reproduction error rate with respect to the disc based on a result of the trial writing into the trial writing, as the recording laser power Pmax.
